(19) United States
(12) Patent Application Publication
(10) Pub. No.: US 2023/0404189 A1
(43) Pub. Date: Dec. 21, 2023

(54) FILTERING ASSEMBLY WITH AN AIR FILTERING FUNCTION

(71) Applicants: Tzu Hwa Hsu, San Jose, CA (US); Daphne HSU, San Jose, CA (US)

(72) Inventors: Tzu Hwa Hsu, San Jose, CA (US); Daphne HSU, San Jose, CA (US)

(21) Appl. No.: 18/074,523

(22) Filed: Dec. 5, 2022

Related U.S. Application Data
(60) Provisional application No. 63/352,649, filed on Jun. 16, 2022.

(51) Int. Cl. A41D 13/11

(52) U.S. Cl. CPC A41D 13/1184; A41D 13/1153

(57) ABSTRACT

A filtering assembly with an air filtering function includes a covering component for at least partially covering a covered body, an opening structure formed on the covering component, and a filtering device removably disposed on the covering component and covering the opening structure. The present invention solves a problem of discomfort of ears or skin and hard breathing caused by wearing a mask in the prior art and allows a user to replace the filtering device according to practical demands. The filtering assembly can be worn by a user directly or used together with a mattress, a bed frame, a child carrier, one of an inlet, an outlet and a built-in filtering element of an air treatment apparatus, a window frame, a door frame, or a head mounted accessory, such as a helmet, a hood, a hat or a cap. Therefore, the present invention has a wide range of applications.

### CROSS REFERENCE TO RELATED APPLICATIONS

This application claims the benefit of U.S. Provisional Application No. 63/352,649, filed on Jun. 16, 2022. The content of the application is incorporated herein by reference.

### BACKGROUND OF THE INVENTION

### 1. Field of the Invention

The present invention relates to a filtering assembly, and more specifically, to a filtering assembly with an air filtering function.

### 2. Description of the Prior Art

Wearing a mask cannot only block a wearer's droplets for preventing the wearer's droplets from leaking out but also block foreign droplets for preventing the foreign droplets from entering the wearer's respiratory channel, so that it reduces transmission of viruses. A higher airtightness of a mask can lead to a better blocking effect of the mask for preventing virus spreading. However, wearing a mask with a higher airtightness causes a problem of discomfort of ears or skin and hard breathing. Besides, a breathing ability of a child is weak, and wearing a mask may cause the child to have difficulty breathing or even to be suffocated. Therefore, it has become a topic in the field to solve the aforementioned problems.

### SUMMARY OF THE INVENTION

It is an objective of the present invention to provide a filtering assembly with an air filtering function for solving the aforementioned problems.

In order to achieve the aforementioned objective, the present invention discloses a filtering assembly with an air filtering function. The filtering assembly includes a covering component, at least one opening structure and at least one filtering device. The covering component is for at least partially covering a covered body. The at least one opening structure is formed on the covering component. The at least one filtering device is removably disposed on the covering component and for covering the at least one opening structure.

According to an embodiment of the present invention, the filtering assembly further includes at least one positioning structure configured to position the at least one filtering device. The at least one positioning structure is disposed on the covering component and adjacent to the at least one opening structure, and the at least one filtering device is movable relative to the covering component when the at least one filtering device is positioned by the at least one positioning structure.

According to an embodiment of the present invention, the at least one positioning structure is an elastic plate structure.

According to an embodiment of the present invention, the filtering assembly further includes at least one combining structure configured to be combined with the at least one filtering device. The at least one combining structure is disposed on the at least one positioning structure, and the at least one filtering device is immovable relative to the covering component when the at least one filtering device is combined with the at least one combining structure.

According to an embodiment of the present invention, the at least one combining structure is a velcro structure.

According to an embodiment of the present invention, the filtering assembly further includes at least one combining structure configured to be combined with the at least one filtering device. The at least one combining structure is disposed on the covering component and adjacent to the at least one opening structure, and the at least one filtering device is immovable relative to the covering component when the at least one filtering device is combined with the at least one combining structure.

According to an embodiment of the present invention, the at least one combining structure is a velcro structure.

According to an embodiment of the present invention, the filtering assembly further includes at least one light transmissible component. At least one window structure is formed on the covering component, and the at least one light transmissible component is disposed on the covering component and covers the window structure.

According to an embodiment of the present invention, the filtering assembly further includes a supporting frame disposed between the covered body and one of the covering component and the filtering device, so as to separate the covered body from the one of the covering component and the filtering component.

According to an embodiment of the present invention, the filtering assembly further includes a tightening component disposed on the covering component and configured to tighten the covering component onto the covered body.

According to an embodiment of the present invention, the filtering assembly further includes a connecting component disposed on the covering component and configured to connect the covering component to the covered body.

According to an embodiment of the present invention, the covered body is a head-and-neck portion of a user, a mattress, a bed frame, a child carrier, at least one of an inlet, an outlet and a built-in filtering element of an air treatment apparatus, a window frame, a door frame, or a head mounted accessory.

According to an embodiment of the present invention, the filtering assembly is a filtering covering.

In order to achieve the aforementioned objective, the present invention further discloses a filtering assembly with an air filtering function. The filtering assembly includes a covering component, at least one opening structure and at least one filtering device. The covering component is for at least partially covering a covered body. The at least one opening structure is formed on at least one of the covering component and the covered body. The at least one filtering device is removably disposed on the at least one of the covering component and the covered body and for covering the at least one opening structure.

In summary, the filtering assembly of the present invention utilizes the covering component for at least partially covering the covered body and further utilizes the filtering device removably disposed on the covering component or the covered body for covering the opening structure formed on the covering component and the covered body. The aforementioned configuration can not only solve a problem of discomfort of ears or skin and hard breathing caused by wearing a mask in the prior art but also allow a user to replace the filtering device according to practical demands. Besides, the filtering assembly of the present invention is not required to be closely attached on the user's cheek, which ensures that a filtering effect of the filter device is not affected by sweat and allows the user to wear an additional mask when wearing the filtering assembly of the present invention, so as to achieve double protection. In addition, the filtering assembly of the present invention can be worn by the user directly or used together with a mattress, a bed frame, a child carrier, at least one of an inlet and an outlet of an air treatment apparatus, a window frame, a door frame, or a head mounted accessory, such as a helmet, a hood, a hat or a cap, and the user can select the filtering assembly with the larger opening structure or with more opening structures according to practical demands, such as ventilation or breathability. Therefore, the present invention has a wide range of applications. Moreover, the present invention also can solve a problem of suffocation of a child.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a filtering assembly in a used state according to a first embodiment of the present invention.

FIG. 2 is a partial diagram of the filtering assembly according to the first embodiment of the present invention.

FIG. 3 is a partial diagram of a filtering assembly according to a second embodiment of the present invention.

FIG. 4 is a partial diagram of a filtering assembly according to a third embodiment of the present invention.

FIG. 5 is a partial diagram of a filtering assembly according a fourth embodiment of the present invention.

FIG. 6 is a diagram of a filtering assembly according to a fifth embodiment of the present invention.

FIG. 7 is a partial internal structural diagram of the filtering assembly in a used state from a top view according to the fifth embodiment of the present invention.

FIG. 8 is a diagram of a filtering assembly in a used state according to a sixth embodiment of the present invention.

FIG. 9 is a diagram of a filtering assembly in a used state according to a seventh embodiment of the present invention.

FIG. 10 is a diagram of a filtering assembly in a used state according to an eighth embodiment of the present invention.

FIG. 11 is a diagram of a filtering assembly in a used state according to a ninth embodiment of the present invention.

FIG. 12 is a diagram of a filtering assembly in a used state according to a tenth embodiment of the present invention.

FIG. 13 is a diagram of a filtering assembly in a used state according to an eleventh embodiment of the present invention.

FIG. 14 is a diagram of a filtering assembly in a used state according to a twelfth embodiment of the present invention.

### DETAILED DESCRIPTION

In the following detailed description of the preferred embodiments, reference is made to the accompanying drawings which form a part hereof, and in which is shown by way of illustration specific embodiments in which the invention may be practiced. In this regard, directional terminology, such as “top”, “bottom”, “left”, “right”, “front”, “back”, etc., is used with reference to the orientation of the Figure(s) being described. The components of the present invention can be positioned in a number of different orientations. As such, the directional terminology is used for purposes of illustration and is in no way limiting. Accordingly, the drawings and descriptions will be regarded as illustrative in nature and not as restrictive. Also, if not specified, the term “connect” is intended to mean either an indirect or direct mechanical connection. Thus, if a first device is connected to a second device, that connection may be through a direct mechanical connection, or through an indirect mechanical connection via other devices and connections.

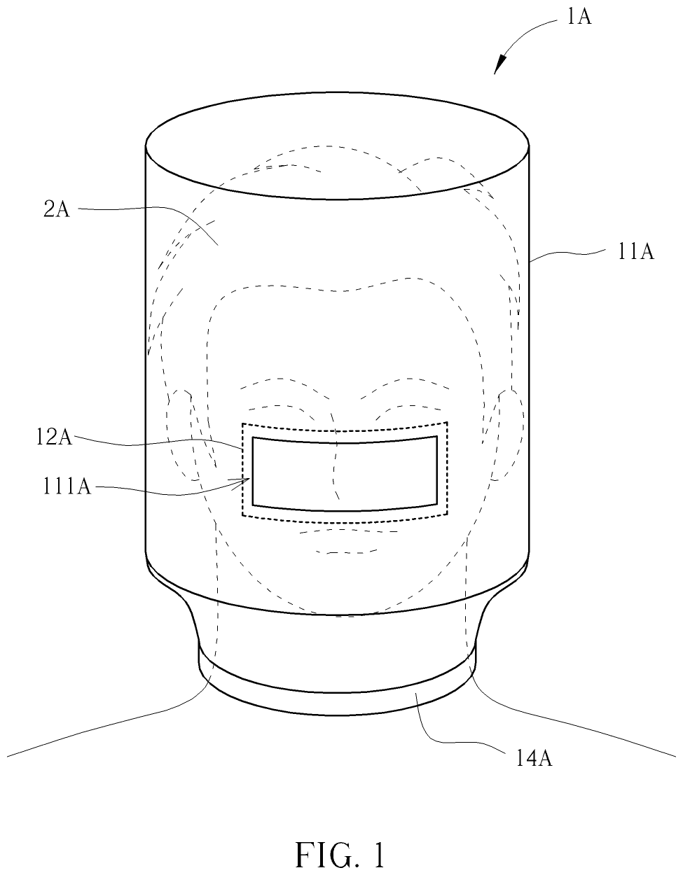

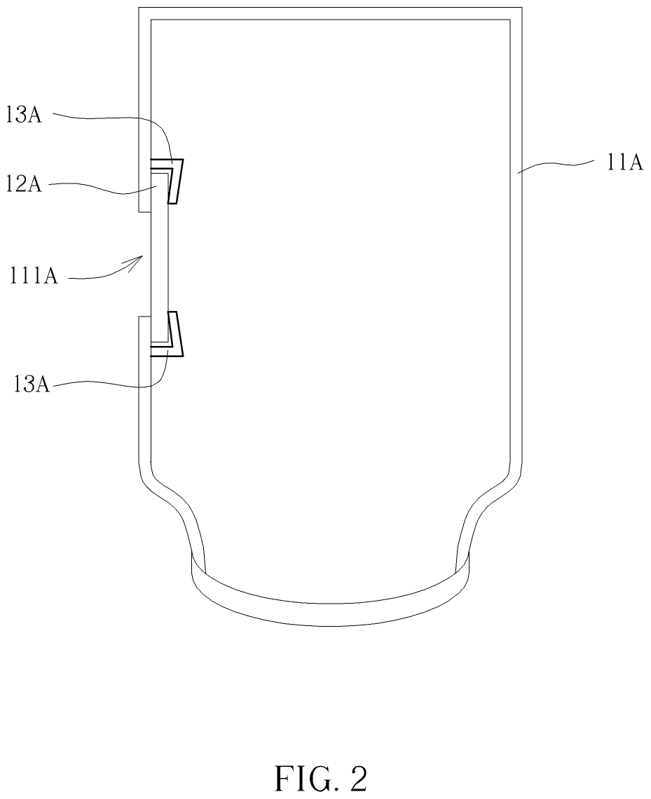

Please refer to FIG. 1 and FIG. 2. FIG. 1 is a diagram of a filtering assembly 1A in a used state according to a first embodiment of the present invention. FIG. 2 is a partial diagram of the filtering assembly 1A according to the first embodiment of the present invention. As shown in FIG. 1 and FIG. 2, the filtering assembly 1A can be a filtering covering with an air filtering function. The filtering assembly 1A includes a covering component 11A, an opening structure 111A and a filtering device 12A. The covering component 11A is for at least partially covering a covered body and can be made of soft or hard materials. The opening structure 111A is formed on the covering component 11A. The filtering device 12A is removably disposed on the covering component 11A and covers the opening structure 111A. The filtering device 12A can include a fiber cloth for filtering air to remove viruses. However, the present invention is not limited thereto. For example, in another embodiment, the filtering device can be used for filtering air to remove dust particles, dust mites or harmful substances, such as formaldehyde or nitrogen dioxide. Besides, the numbers and the locations of the opening structure and the filtering device can be configured according to practical demands. For example, in another embodiment, there can be a plurality of opening structures formed on the covering component and located correspondingly to a user's nose-and-mouth portion and a plurality of filtering devices respectively covering the plurality of opening structures, so that the filtering assembly can have improved ventilation or breathability.

Specifically, the filtering assembly LA further includes two positioning structures 13A for positioning the filtering device 12A. The two positioning structures 13A are disposed on the covering component 11A and adjacent to the opening structure 111A. When the filtering device 12A is positioned by the two positioning structures 13A, the filtering device 12A is movable relative to the covering component 11A. More specifically, the two positioning structures 13A can be two elastic plate structures disposed on an inner side of the covering component 11A and respectively adjacent to an upper side and a lower side of the opening structure 111A. The user can operate the filtering device 12A to slide an upper portion and a lower portion of the filtering device 12A into the two positioning structures 13A, so as to attach the filtering device 12A onto the inner side of the covering component 11A by resilient engagement of the two positioning structures 13A and the upper portion and the lower portion of the filtering device 12A. On the other hand, the user can operate the filtering device 12A to slide the upper portion and the lower portion of the filtering device 12A out of the two positioning structures 13A, so as to remove the filtering device 12A from the covering component 11A. The number of the positioning structure is not limited to this embodiment. For example, in another embodiment, there can be one or more positioning structures disposed on an inner side or/and an outer side of the covering component and adjacent to the upper side or/and the lower side of the opening structure. Alternatively, in another embodiment, there can be no positioning structure.

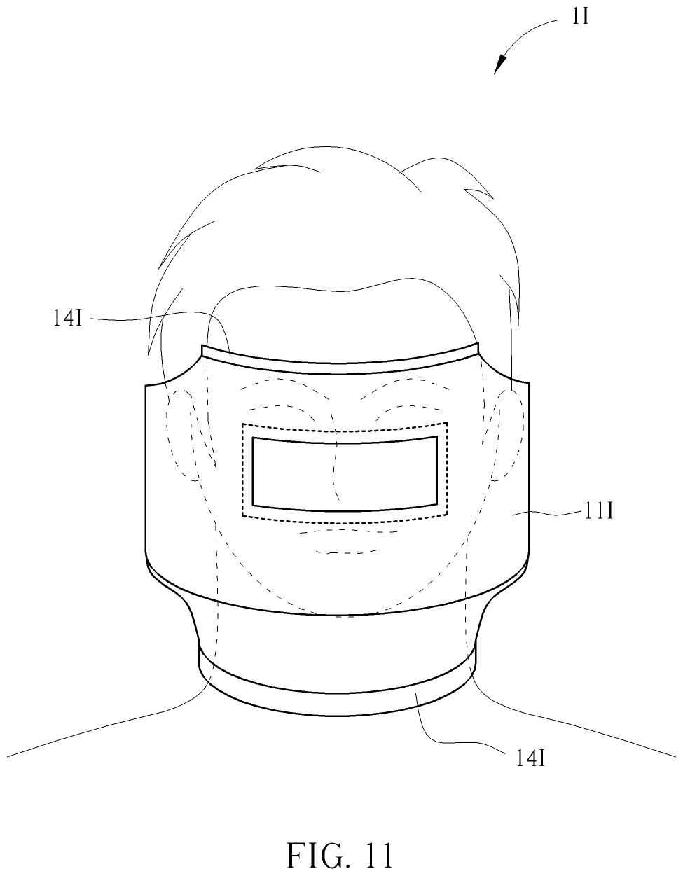

Moreover, the filtering assembly 1A further includes a tightening component 14A disposed on the covering component 11A and for tightening the covering component 11A onto a covered body 2A. In this embodiment, when the user wears the filtering assembly 1A on his/her head-and-neck portion, i.e., the covered body 2A is the user's head-and-neck portion, the tightening component 14A disposed on the covering component 11A can tighten the covering component 11A onto the user's head-and-neck portion for preventing any gap formed between the covering component 11A and the user's head-and-neck portion. In this embodiment, the tightening component 14A can be an elastic band which is capable of elastically extending and retracting. However, the present invention is not limited to this embodiment. For example, in another embodiment, the tightening component can be a strap which is incapable of elastically extending and retracting. Alternatively, in another embodiment, there can be no tightening component, and the user can place edges of the covering component inside his/her clothes, i.e., the user can use his/her clothes to cover the edges of the covering component. Alternatively, in another embodiment, there can be a plurality of tightening components. For example, please refer to FIG. 11. FIG. 11 is a diagram of a filtering assembly 1I in a used state according to a ninth embodiment of the present invention. As shown in FIG. 11, the filtering assembly 11 can include two tightening components 14I. When the user wears the filtering assembly 1I on his/her hand-and-neck portion, the two tightening components 14I can respectively tighten an upper edge and a lower edge of a covering component 11I onto an upper side and a lower side of the user's head-and-neck portion, so as to expose the user's scalp for keeping the user's scalp and/or hair away from heat and humidity. Understandably, in another embodiment, the upper side of the covering component can be attached on a portion of the user's cheek below the user's eyes to expose the user's eyes.

Furthermore, the covering component 11A can be at least partially made of light transmissible material for allowing the user to see an external environment clearly, so as to ensure using safety and convenience. In addition, when the user wears the filtering assembly LA, the user can move the opening structure 111A and the filtering device 12A to a rear side of his/her head-and-neck portion for allowing other people to see his/her facial features and facial expressions clearly.

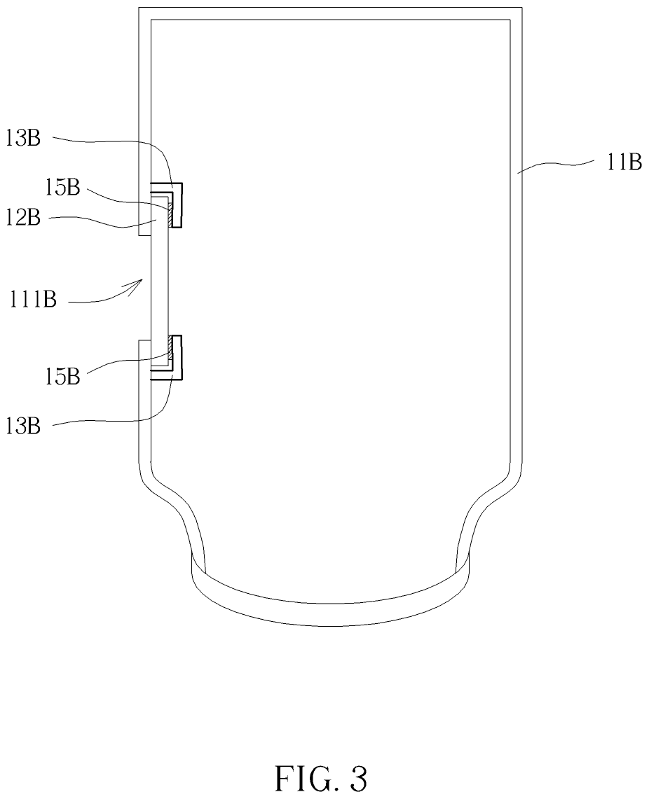

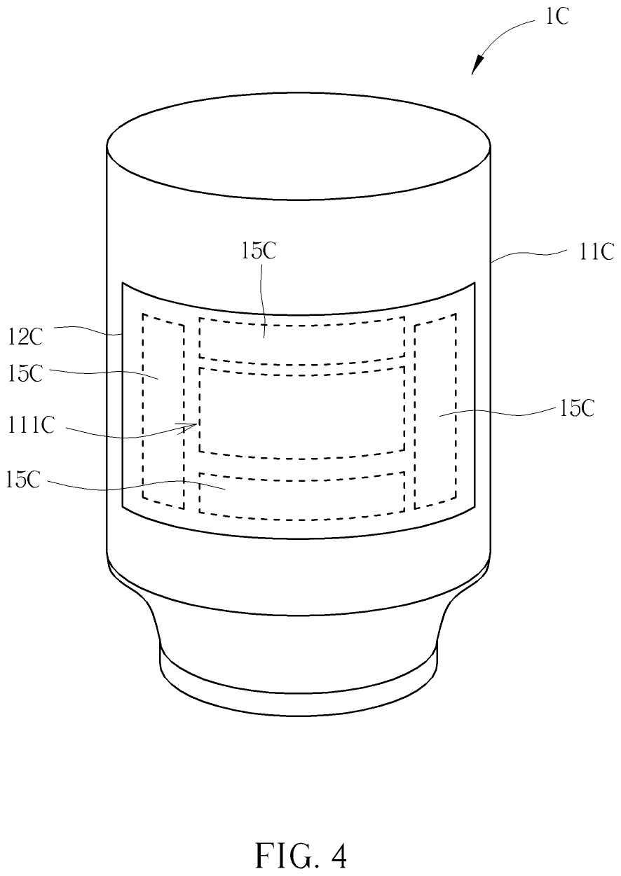

It should be noted that disposal of the filtering device is not limited to the aforementioned embodiment. For example, please refer to FIG. 3 and FIG. 4. FIG. 3 is a partial diagram of a filtering assembly 1B according to a second embodiment of the present invention. FIG. 4 is a partial diagram of a filtering assembly 1C according to a third embodiment of the present invention. As shown in FIG. 3, different from the first embodiment, the filtering assembly 1B of the second embodiment further includes two combining structures 15B configured to be combined with a filtering device 12B. When the filtering device 12B is combined with the two combining structures 15B, the filtering device 12B is immovable relative to a covering component 11B. Specifically, the two combining structures 15B can be two velcro structures disposed on two positioning structures 13B respectively. After the user operates the filtering device 12B to slide an upper portion and a lower portion of the filtering device 12B into the two positioning structures 13B to resiliently engage the two positioning structures 13B with the upper portion and the lower portion of the filtering device 12B, the user can press the upper portion and the lower portion of the filtering device 12B, so that the upper portion and the lower portion of the filtering device 12B are respectively combined with the two combining structures 15B for completing disposal of the filtering device 12B. When it is desired to remove the filtering device 12B from the covering component 11B, the user can pull the filtering device 12B to disengage the upper portion and the lower portion of the filtering device 12B from the two combining structures 15B, and then the user can operate the filtering device 12B to slide the upper portion and the lower portion of the filtering device 12B out of the two positioning structures 13B. However, the number of the combining structure is not limited to this embodiment. For example, in another embodiment, there can be only one combining structure disposed on one positioning structure.

As shown in FIG. 4, different from the first embodiment, the filtering assembly 1C of the third embodiment does not include any positioning structure but includes four combining structures 15C disposed on an outer side of a covering component 11C and adjacent to an opening structure 111C for being combined with a filtering device 12C. When the filtering device 12C is combined with the four combining structures 15C, the filtering device 12C is located at the outer side of the covering component 11C and immovable relative to the covering component 11C. Specifically, the four combining structures 15C can be four velcro structures respectively located adjacent to an upper side, a lower side, a left side and a right side of the opening structure 111C. The user can operate the filtering device 12C to adhesively combine an upper portion, a lower portion, a left portion and a right portion of the filtering device 12C with the four combining structures 15C respectively for completing disposal of the filtering device 12C. The user can operate the filtering device 12C to disengage the upper portion, the lower portion, the left portion and the right portion of the filtering device 12C from the four combining structures 15C respectively for allowing removal of the filtering device 12C from the covering component 11C. The number of the combining structure is not limited to this embodiment. For example, in another embodiment, there can be only one combining structure adjacent to the upper side, the lower side, the left side or the right side of the opening structure.

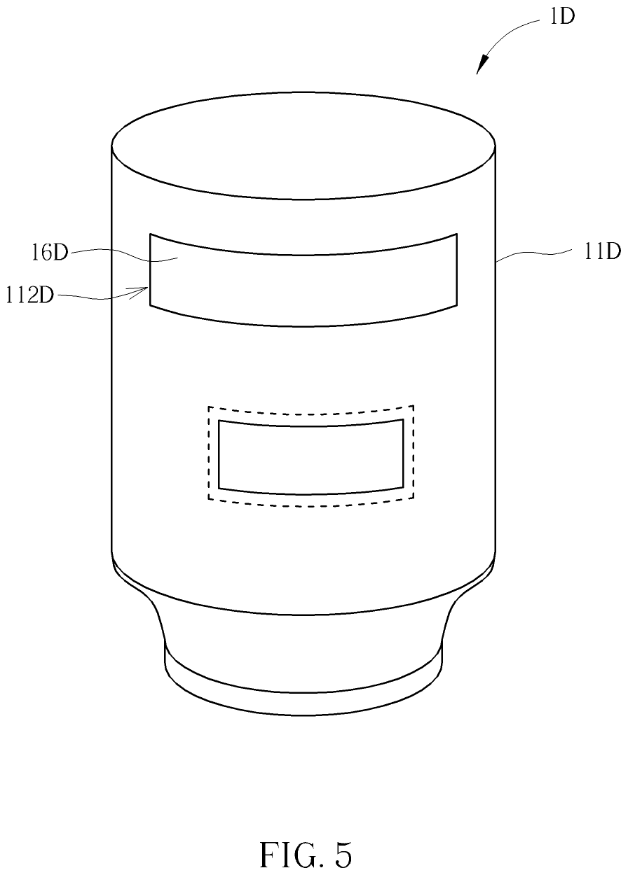

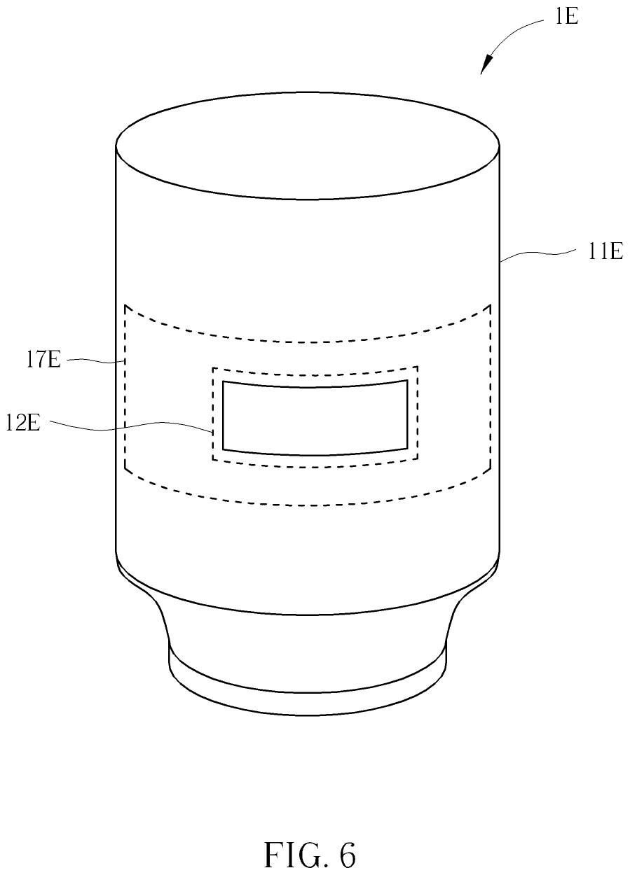

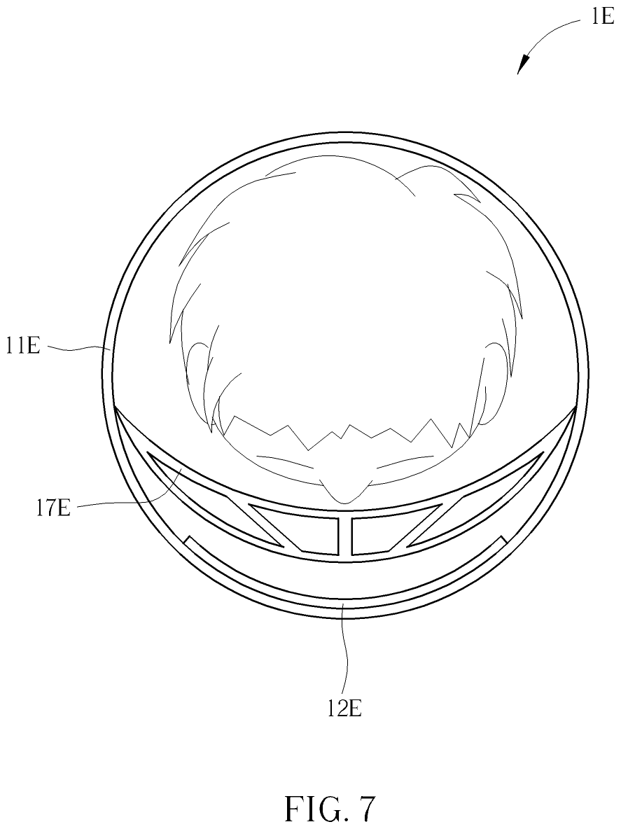

Please further refer to FIG. 5 to FIG. 7. FIG. 5 is a partial diagram of a filtering assembly 1D according a fourth embodiment of the present invention. FIG. 6 is a diagram of a filtering assembly 1E according to a fifth embodiment of the present invention. FIG. 7 is a partial internal structural diagram of the filtering assembly 1F in a used state from a top view according to the fifth embodiment of the present invention. As shown in FIG. 5, different from the first embodiment, a covering component 11D of the filtering assembly 1D is made of opaque material, and a window structure 112D is formed on the covering component 11D. The filtering assembly 1D further includes a light transmission component 16D disposed on the covering component 11D and covering the window structure 112D. The light transmissible component 16D is located correspondingly to the user's eye portion for allowing the user to see the external environment clearly. The filtering assembly 1D does not include any tightening component. The user can place edges of the covering component 11D inside his/her clothes. Other details of the fourth embodiment are similar to the ones of the first embodiment. Detailed description is omitted herein for simplicity.

As shown in FIG. 6 and FIG. 7, different from the aforementioned embodiments, the filtering assembly 1E further includes a supporting frame 17E disposed between a covering component 11E and the covered body for separating the covering component 11E from the covered body, so as to prevent the covering component 11E or a filtering device 12E from being closely attached on the covered body. Other details of the fifth embodiment can be similar to the ones of any one of the aforementioned embodiments. Detailed description is omitted for simplicity. Besides, the location of the supporting frame is not limited to this embodiment. For example, in another embodiment, the supporting frame can be disposed between the filtering device and the covered body for separating the filtering device from the covered body, so as to prevent the filtering device from being closely attached on the covered body. Besides, understandably, in another embodiment, there can be no supporting frame when the covering component has enough mechanical strength and is not closely attached on the covered body.

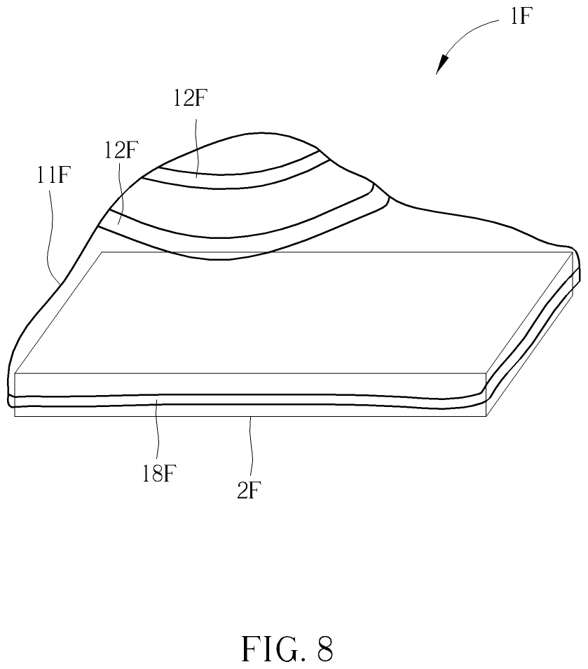

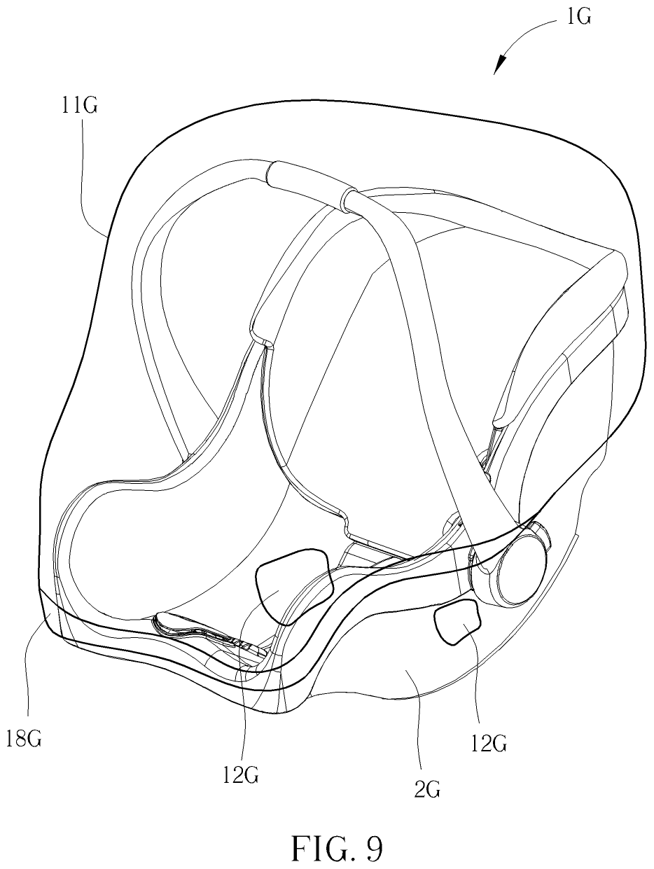

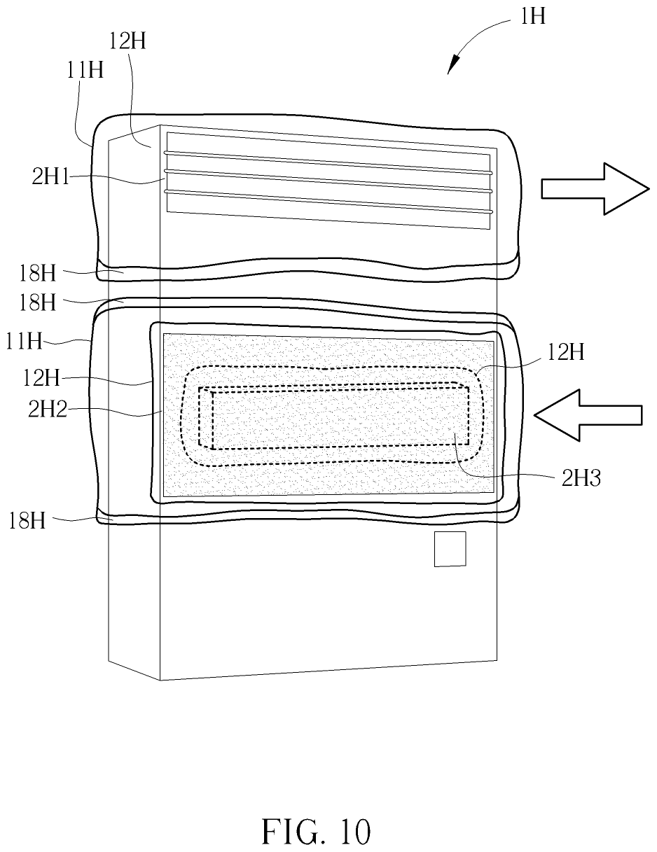

The filtering assembly of the present invention can be worn by the user directly or used together with another object, such as a mattress, a bed frame, a child carrier, at least one of an inlet, an outlet and a built-in filtering element of an air treatment apparatus, e.g., an air exchanger, an air conditioner, a heater, a humidifier or a dehumidifier, a window frame, a door frame, or a head mounted accessory, e.g., a helmet, a hood, a hat or a cap. For example, please refer to FIG. 8 to FIG. 10. FIG. 8 is a diagram of a filtering assembly 1F in a used state according to a sixth embodiment of the present invention. FIG. 9 is a diagram of a filtering assembly 1G in a used state according to a seventh embodiment of the present invention. FIG. 10 is a diagram of a filtering assembly 1H in a used state according to an eighth embodiment of the present invention. As shown in FIG. 8, a covered body 2F is a mattress. A covering component 11F of the filtering assembly 1F at least partially covers the mattress. Two opening structures are elongated and formed on a top portion of the covering component 11F away from the covered body 2F. The filtering assembly 1F include two filtering devices 12F covering the two opening structures respectively. The filtering assembly 1F further includes a connecting component 18F disposed on the covering component 11F and for connecting the covering component 11F to the mattress, so as to prevent any gap formed between the covering component and the mattress. The user can be covered by the filtering assembly 1F when the user lies on the mattress.

As shown in FIG. 9, a covered body 2G is a child carrier. Specifically, in the seventh embodiment, the covered body 2G is a child basket. However, the present invention is not limited to this embodiment. For example, in another embodiment, the child carrier can be a child stroller or a child safety seat. A covering component 11G of the filtering assembly 1G at least partially covers the child basket. A connecting component 18G is disposed on the covering component 11G and for connecting the covering component 11G to the child basket, so as to prevent any gap formed between the covering component 11G and the child basket. Specifically, in the seventh embodiment, the covering component 11G and a canopy of the child carrier can be two independent structures. However, the present invention is not limited to this embodiment. For example, in another embodiment, the covering component and the canopy of the child carrier can be integrally combined with each other. Besides, the filtering assembly 1G includes two opening structures and two filtering devices 12G for covering the two opening structures respectively. The two opening structures are formed on a front side of the covering component 11G and a front side of a side panel of the child basket respectively for preventing an unintentional touch by the child. A child can be covered by the filtering assembly 1G when the child sits in the child basket. Understandably, the locations, the sizes or the numbers of the opening structure and the filtering device can be configured according to practical demands for ensuring the child to breath smoothly. For example, in another embodiment, there can be only one opening structure located on a rear side of the covering component or a rear side of the side panel of the child basket, and one filtering device.

As shown in FIG. 10, two covered bodies 2H1 and 2H2 are an outlet and an inlet of an air treatment apparatus. Specifically, in the eighth embodiment, the two covered bodies 2H1 and 2H2 are an outlet and an inlet of a commercial packaged air treatment apparatus. The filtering assembly 1H includes three covering components 11H and three filtering devices 12H. There can be two connecting components 18H disposed on a lower one of the covering components 11H at least partially covering the inlet for preventing any gap formed between the inlet and the lower one of the covering components 11H. There can be one connecting component 18H disposed on an upper one of the covering components 11H at least partially covering the outlet for preventing any gap formed between the outlet and the upper one of the covering components 11H. The two filtering devices 12H cover the two opening structures formed on the upper and lower covering components 11H respectively and located at a front side of the inlet and a front side of the outlet for filtering air flowing toward the inlet and flowing from the outlet respectively. Besides, the other one of the covering components 11H located inside the air treatment apparatus can be attached on a built-in filtering element 2H3 of the air treatment apparatus by at least one connecting component or at least one tightening component and at least partially covers the built-in filtering element 2H3 of the air treatment apparatus for filtering air flowing through the built-in filtering element 2H3. Understandably, the covered body can be an outlet, an inlet or a built-in filtering element of any type of air treatment apparatus with a function of cooling, heating or dehumidifying, and there can be only one covering component for at least partially covering the outlet, the inlet, or the built-in filtering element of the air treatment apparatus, and one filtering device.

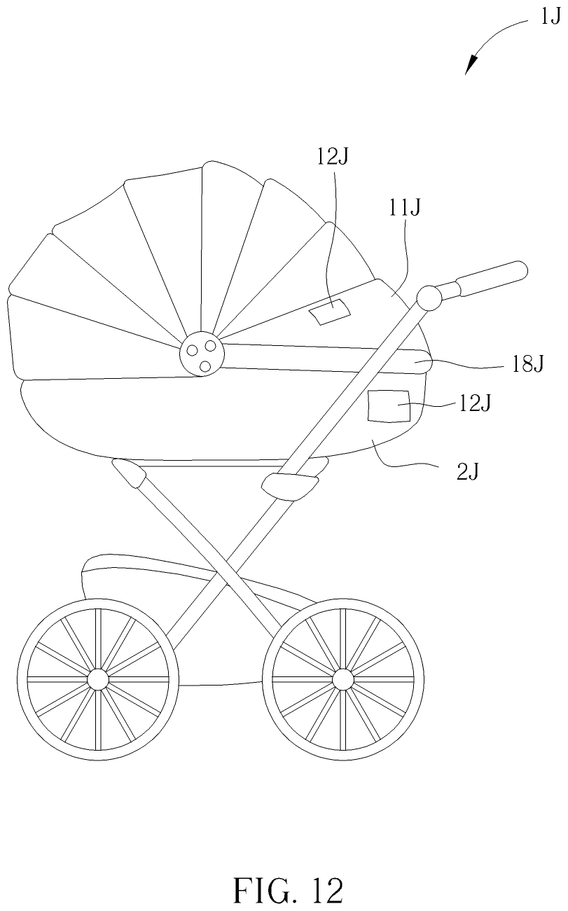

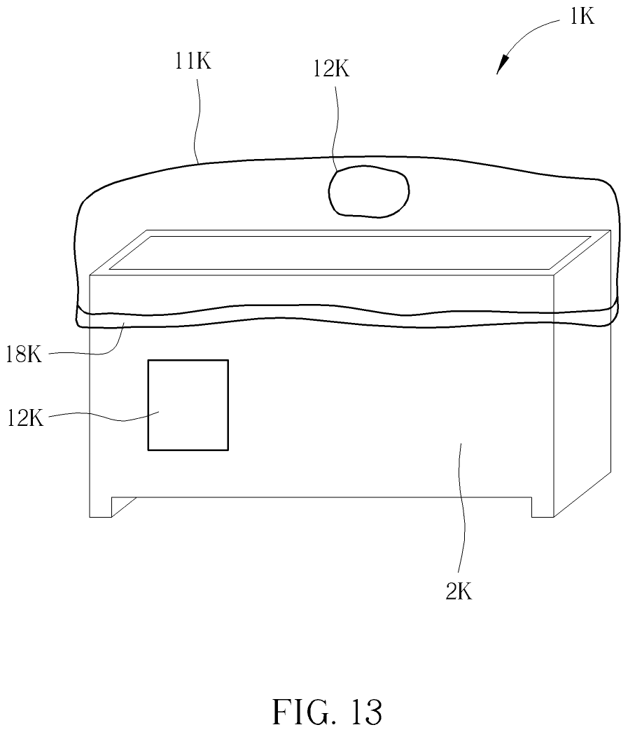

Please further refer to FIG. 12 to FIG. 13. FIG. 12 is a diagram of a filtering assembly 1J in a used state according to a tenth embodiment of the present invention. FIG. 13 is a diagram of a filtering assembly 1K in a used state according to an eleventh embodiment of the present invention. As shown in FIG. 12, a covered body 2J is a child stroller. A covering component 11J of the filtering assembly 1J is integrally combined with a canopy of the child stroller and at least partially covers the child stroller. A connecting component 18J is disposed on the covering component 11J and for connecting the covering component 11J to the child stroller, so as to prevent any gap formed between the covering component 11J and the child stroller. The filtering assembly 1J includes two opening structures and two filtering devices 12J. The two opening structures are formed on the covering component 11J and a side panel of the child stroller respectively. The two filtering devices 12J are respectively disposed on the covering component 11J and the side panel of the child stroller and respectively cover the two opening structures. Understandably, the locations, the sizes or the numbers of the opening structure and the filtering device can be configured according to practical demands for ensuring the child to breath smoothly. For example, in another embodiment, there can be only one opening structure located on the covering component or the side panel of the child stroller, and one filtering device.

As shown in FIG. 13, a covered body 2K is abed frame. A covering component 11K of the filtering assembly 1K at least partially covers the bed frame. A connecting component 18K is disposed on the covering component 11K and for connecting the covering component 11K to the bed frame, so as to prevent any gap formed between the covering component 11K and the bed frame. The filtering assembly 1K includes two opening structures and two filtering devices 12K. The two opening structures are formed on the covering component 11K and a lateral portion of the bed frame respectively. The two filtering devices 12K are respectively disposed on the covering component 11K and the bed frame and respectively cover the two opening structures. Understandably, the locations, the sizes or the numbers of the opening structure and the filtering device can be configured according to practical demands for ensuring the child to breath smoothly. For example, in another embodiment, there can be only one opening structure formed on the covering component or the lateral portion of the bed frame, and one filtering device.

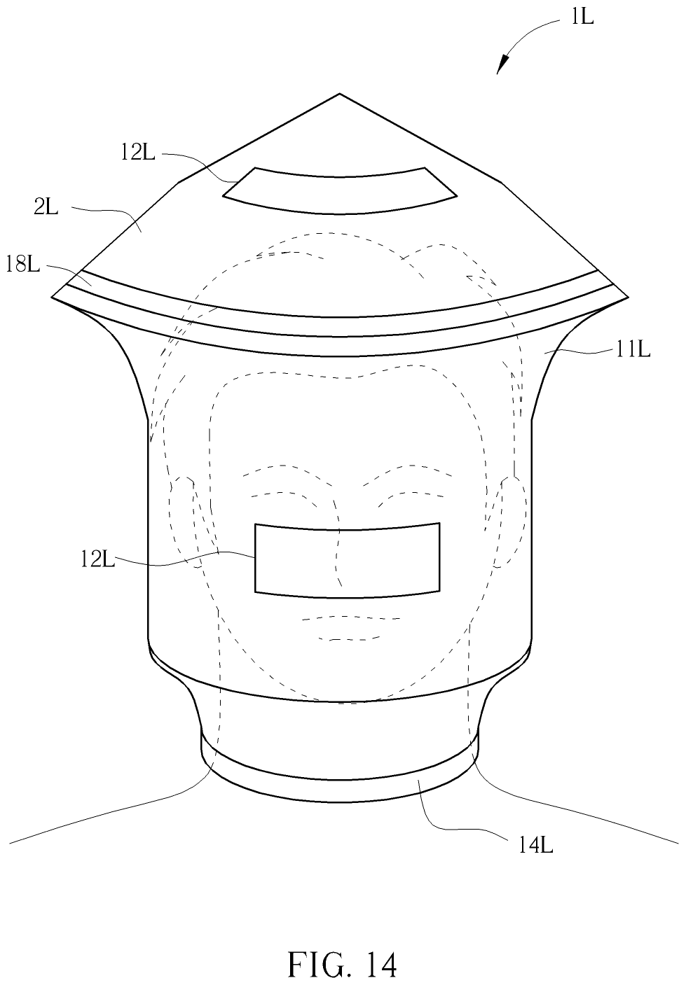

Please further refer to FIG. 14. FIG. 14 is a diagram of a filtering assembly 1L in a used state according to a twelfth embodiment of the present invention. As shown in FIG. 14, a covered body 2L is a hat for the user to wear. An upper edge of a covering component 11L of the filtering assembly 1L can be connected to the hat by a connecting component 18L. A lower edge of the covering component 11L of the filtering assembly 1L can be tightened on the user's head-and-neck portion by a tightening component 14L. The filtering assembly 1L includes two opening structures and two filtering devices 12L. The two opening structures are formed on the covering component 11L and the hat respectively. The two filtering devices 12K are respectively disposed on the covering component 11L and the hat and respectively cover the two opening structures. Understandably, the locations, the sizes or the numbers of the opening structure and the filtering device can be configured according to practical demands for ensuring the child to breath smoothly. For example, in another embodiment, there can be only one opening structure formed on the covering component or the hat, and one filtering device.

The connecting component of any one of the aforementioned embodiments can be a double-sided tape, a velcro tape or a zipper. In another embodiment, the filtering assembly also can utilize the tightening component for tightening the covering component onto the hat, the mattress or any other child carrier, and the connecting component can be omitted.

Besides, the filtering assembly of any one of the aforementioned embodiments and the covered body, such as the mattress, the bed frame, the hat, the hood, the child stroller, the child basket or the air treatment apparatus, can cooperatively form a filtering set with an air filtering function.

The aforementioned embodiments can effectively prevent the user from contracting a disease. Since immunity of the child is low, the filtering assembly used together with the child carrier is valuable.

In contrast to the prior art, the filtering assembly of the present invention utilizes the covering component for at least partially covering the covered body and further utilizes the filtering device removably disposed on the covering component or the covered body for covering the opening structure formed on the covering component and the covered body. The aforementioned configuration can not only solve a problem of discomfort of ears or skin and hard breathing caused by wearing a mask in the prior art but also allow a user to replace the filtering device according to practical demands. Besides, the filtering assembly of the present invention is not required to be closely attached on the user's cheek, which ensures that a filtering effect of the filter device is not affected by sweat and allows the user to wear an additional mask when wearing the filtering assembly of the present invention, so as to achieve double protection. In addition, the filtering assembly of the present invention can be worn by the user directly or used together with a mattress, a bed frame, a child carrier, at least one of an inlet, an outlet and a built-in filtering element of an air treatment apparatus, a window frame, a door frame, or a head mounted accessory, such as a helmet, a hood, a hat or a cap, and the user can select the filtering assembly with the larger opening structure or with more opening structures according to practical demands, such as ventilation or breathability. Therefore, the present invention has a wide range of applications. Moreover, the present invention also can solve a problem of suffocation of a child.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A filtering assembly with an air filtering function, the filtering assembly comprising:
a covering component for at least partially covering a covered body;
at least one opening structure formed on the covering component; and
at least one filtering device removably disposed on the covering component and for covering the at least one opening structure.

2. The filtering assembly of claim 1, further comprising at least one positioning structure configured to position the at least one filtering device, the at least one positioning structure being disposed on the covering component and adjacent to the at least one opening structure, and the at least one filtering device being movable relative to the covering component when the at least one filtering device is positioned by the at least one positioning structure.

3. The filtering assembly of claim 2, wherein the at least one positioning structure is an elastic plate structure.

4. The filtering assembly of claim 2, further comprising at least one combining structure configured to be combined with the at least one filtering device, the at least one combining structure being disposed on the at least one positioning structure, and the at least one filtering device being immovable relative to the covering component when the at least one filtering device is combined with the at least one combining structure.

5. The filtering assembly of claim 4, wherein the at least one combining structure is a velcro structure.

6. The filtering assembly of claim 1, further comprising at least one combining structure configured to be combined with the at least one filtering device, the at least one combining structure being disposed on the covering component and adjacent to the at least one opening structure, and the at least one filtering device being immovable relative to the covering component when the at least one filtering device is combined with the at least one combining structure.

7. The filtering assembly of claim 6, wherein the at least one combining structure is a velcro structure.

8. The filtering assembly of claim 1, further comprising at least one light transmissible component, at least one window structure being formed on the covering component, and the at least one light transmissible component being disposed on the covering component and covering the window structure.

9. The filtering assembly of claim 1, further comprising a supporting frame disposed between the covered body and one of the covering component and the filtering device, so as to separate the covered body from the one of the covering component and the filtering component.

10. The filtering assembly of claim 1, further comprising a tightening component disposed on the covering component and configured to tighten the covering component onto the covered body.

11. The filtering assembly of claim 1, further comprising a connecting component disposed on the covering component and configured to connect the covering component to the covered body.

12. The filtering assembly of claim 1, wherein the covered body is a head-and-neck portion of a user, a mattress, a bed frame, a child carrier, at least one of an inlet, an outlet and a built-in filtering element of an air treatment apparatus, a window frame, a door frame, or a head mounted accessory.

13. The filtering assembly of claim 1, where the filtering assembly is a filtering covering.

14. A filtering assembly with an air filtering function, the filtering assembly comprising:
a covering component for at least partially covering a covered body;
at least one opening structure formed on at least one of the covering component and the covered body; and
at least one filtering device removably disposed on the at least one of the covering component and the covered body and for covering the at least one opening structure.
